(19) United States
(12) Patent Application Publication
(10) Pub. No.: US 2015/0136829 A1
(43) Pub. Date: May 21, 2015

(54) TOOL ENHANCEMENTS

(71) Applicant: Revive Construction LLC, Portland, OR (US)

(72) Inventor: Clint Elijah Howes, Portland, OR (US)

(21) Appl. No.: 14/542,972

(22) Filed: Nov. 17, 2014

Related U.S. Application Data
(60) Provisional application No. 62/023,094, filed on Jul. 10, 2014.
(60) Provisional application No. 61/906,833, filed on Nov. 20, 2013.

(51) Int. Cl. B25C 1/04

(52) U.S. Cl. CPC B25C 1/04
USPC 227/140

(57) ABSTRACT

Tool enhancements, and related systems and techniques, are disclosed herein. For example, a nail gun may include a trigger; an actuator to drive a nail in response to a pull of the trigger; a sensor to generate data indicative of a property of operation of the nail gun prior to or during driving of a nail, wherein the property is a resistance experienced by the nail as it is driven or an angle at which the nail is driven; monitoring circuitry to determine whether the data generated by the sensor satisfies a predetermined event condition; and an output interface to provide an indicator that the predetermined event condition has been satisfied in response to a determination by the monitoring circuitry that the predetermined event condition has been satisfied. Other embodiments may be disclosed and/or claimed.

### CROSS-REFERENCE TO RELATED APPLICATIONS

This application claims priority to U.S. Provisional Patent Application No. 61/906,833, filed on Nov. 20, 2013, and titled “PNEUMATIC TOOL ENHANCEMENTS,” and to U.S. Provisional Patent Application No. 62/023,094, filed on Jul. 10, 2014, and titled “TOOL ENHANCEMENTS,” the disclosures of both of which are incorporated herein by reference in their entireties.

### TECHNICAL FIELD

The present disclosure relates generally to the field of power tools, and more particularly, to tool enhancements.

### BACKGROUND

Despite incredible technological improvement in most areas of modern life, pneumatic tools, particularly nail guns, have remained essentially unchanged for decades. A pneumatic nail gun is loaded with a magazine that contains nails before firing. Nails are fed into a chamber, and compressed air provides the hammering force. One or more piston cylinders draw air from a compressed air source, which is used to force a piston head into the chamber in response to a trigger pull. The piston forces the nail out of the chamber and into the target substrate.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a tool monitoring/control system, in accordance with various embodiments.

FIG. 2 depicts a memory structure that may be stored in a memory device of a tool monitoring/control system, in accordance with various embodiments.

FIG. 3 schematically illustrates various components of a nail gun as a nail is driven into a workpiece, in accordance with various embodiments.

FIG. 4 is a perspective view of a portion of a nose piece of a nail gun having an optical sensor, in accordance with various embodiments.

FIGS. 5-6 are side views of the operation of the nail gun of FIG. 4 when the nose piece of the nail gun is oriented at different angles with respect to a workpiece, in accordance with various embodiments.

FIG. 7 is a perspective view of a nose piece of a nail gun having a magnetic sensor, in accordance with various embodiments.

FIGS. 8-9 are side views of the operation of the nail gun of FIG. 7 when the nose piece of the nail gun is oriented at different angles with respect to a workpiece, in accordance with various embodiments.

FIG. 10 schematically illustrates various output interface components that may be included in a nail gun, in accordance with various embodiments.

FIG. 11 depicts a first illustrative graphical user interface (GUI) that may be displayed on a remote monitoring device based on data provided by a number of tools configured in accordance with various embodiments of the tool monitoring/control systems disclosed herein.

FIG. 12 depicts a second illustrative GUI that may be displayed on a remote monitoring device based on data provided by a number of tools configured in accordance with various embodiments of the tool monitoring/control systems disclosed herein.

FIG. 13 depicts a third illustrative GUI that may be displayed on a remote monitoring device based on data provided by a tool configured with various embodiments of the tool monitoring/control systems disclosed herein.

FIG. 14 is a flow diagram of a method for operating a tool, in accordance with various embodiments.

### DETAILED DESCRIPTION

Tool enhancements, and related systems and techniques, are disclosed herein. For example, a nail gun may include a trigger; an actuator to drive a nail in response to a pull of the trigger; a sensor to generate data indicative of a property of operation of the nail gun prior to or during driving of a nail, wherein the property is a resistance experienced by the nail as it is driven or an angle at which the nail is driven; monitoring circuitry to determine whether the data generated by the sensor satisfies a predetermined event condition; and an output interface to provide an indicator that the predetermined event condition has been satisfied in response to a determination by the monitoring circuitry that the predetermined event condition has been satisfied. Various ones of the embodiments disclosed herein may enable circuitry included in a tool (such as a nail gun) to monitor performance of the tool. Performance data may be reported to a manager for automated performance evaluation and/or provided as feedback to the operator of the tool so that he or she will know if the tool has been or is being used properly.

With conventional tools, a user can typically specify the amount of hammering force to be delivered by a nail gun in order to accommodate various substrates and nails. However, no additional information is typically conveyed to a user. For example, conventional nail guns typically do not provide a user with information regarding the presence of a nail in the chamber or in the magazine. If a nail gun runs out of nails and “dry fires,” it will not be readily apparent to the user because the piston head will impact the substrate, which causes an indentation in the substrate that can cause a user to believe that a nail has successfully been inserted.

Additionally, conventional nail guns can fail for a variety of reasons, including failure of air pressure and jammed mechanisms, and without an indication of what the problem is, users cannot typically differentiate between causes of failure without time-consuming inspection and trial and error.

Conventional nail guns are used for applications such as rough carpentry, for example, framing. Finish carpentry and other applications wherein aesthetics are critical also benefit from the ease of use and speed of a nail gun, but require a high level of control in order to ensure that the operation of the tool does not interfere with the aesthetic requirements of the job. For example, when a nail gun dry fires, a user must then insert nails into the indentations left in the wood by the piston. This is challenging. Also, in fine applications, a user needs enhanced control over the power exerted by the tool and the placement of nails.

Conventional nail guns do not typically have an electrical power source. They operate only through the mechanical action caused by air pressure. Therefore, they include no means of powering electronic sensors or user interface functionality.

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description uses the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. As used herein, the phrase “coupled” may mean that two or more elements are in direct physical or electrical contact, or that two or more elements are not in direct contact with each other, but yet still cooperate or interact with each other (e.g., via one or more intermediate elements, which may perform their own transformations or have their own effects). For example, two elements may be coupled to each other when both elements communicate with a common element (e.g., a memory device). As used herein, the term “logic” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality. As used herein, a signal may be “received” by a component if it is generated externally or internally to that component, and acknowledged and/or processed by that component.

Disclosed herein are several improvements to traditional pneumatic tools, particularly nail guns:

1. Power generation within the device.

2. Storage of that power.

3. Measurement of critical parameters such as piston behavior, chamber contents, and magazine contents.

4. Storage of data.

5. Output of data to the user.

6. User adjustment of tool behavior.

7. Features that otherwise enhance ease of use.

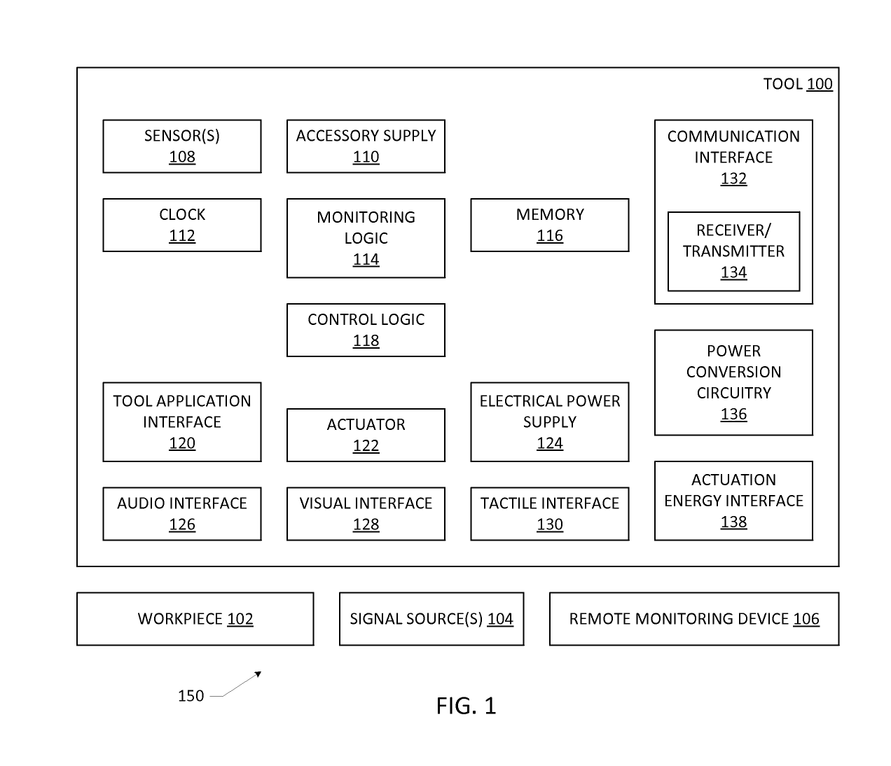

FIG. 1 is a block diagram of a tool monitoring/control system 150 including a tool 100, in accordance with various embodiments. Although “pneumatic tools” may be referred to herein, this is simply for illustrative purposes and the teachings of the present disclosure apply to all suitable pneumatic and non-pneumatic tools (e.g., any tool with some form of mechanical action or power/fuel supply, such as drills, saws (e.g., miter saws), cordless tools, etc). Thus, the tool 100 may be a pneumatic tool or a non-pneumatic tool.

The tool 100 may include an actuation energy interface 138. The actuation energy interface 138 may include any suitable hardware for receiving energy from an energy source external to the tool 100. For example, when the tool 100 is a pneumatic tool, the actuation energy interface 138 may include hardware (e.g., an air hose and other hardware) for receiving a compressed gas that may be used to actuate the tool (e.g., driving a nail with a nail gun). The actuation energy interface 138 may include hardware (e.g., electrically conductive cabling) for receiving electric energy from a wall socket or other conventional electric energy source.

In some embodiments, the tool 100 may include power conversion circuitry 136. The power conversion circuitry 136 may be coupled to the actuation energy interface 138 and may be configured to convert the energy received at the actuation energy interface 138 into a different form. For example, the power conversion circuitry 136 may be configured to convert alternating current (AC) electrical energy into direct current (DC) electrical energy. In another example, the power conversion circuitry 136 may be configured to convert AC or DC electrical energy into stored energy. The stored energy may be electrically stored energy (e.g., in a capacitor or battery), mechanically stored energy (e.g., in a spring under tension or compression), pneumatically stored energy (e.g., by compressing a fluid included in a reservoir in the tool 100), any other suitable stored energy, or any combination of types of stored energy. When the power conversion circuitry 136 converts energy received at the actuation energy interface 138 into electrical power, the power conversion circuitry 136 may be coupled to an electrical power supply 124, and electrical power may be stored in the electrical power supply 124 for further use by the tool 100.

In some embodiments, the power conversion circuitry 136 may include hardware for converting pneumatic energy received at the actuation energy interface 138 into electrical energy stored in the electrical power supply 124. For example, power may be generated through the use of piezoelectric elements or magnets using the air incoming through the air hose. For example, U.S. Patent Application Publication No. 2009/0167114 describes one such mechanism for developing power through air pressure. One or more batteries located onboard a device (e.g., included in the electrical power supply 124 of the tool 100) may store power that has been generated or may provide power in addition to or in lieu of power generated by the device. A battery may also act as a wattage buffer between the generating device (e.g., external to the tool 100, not shown) and the consuming device (e.g., the tool 100). Additionally or alternatively, power generated by the device may be stored in a capacitor (e.g., one or more capacitors included in the electrical power supply 124).

The tool 100 may include an accessory supply 110. The accessory supply 110 may be the source of a resource consumed by the tool 100 during operation of the tool 100. For example, if the tool 100 is a nail gun, the accessory supply 110 may include a cartridge or other supply of nails to be driven by the tool 100.

The tool 100 may include one or more sensors 108. The sensors 108 may be coupled to any suitable component of the tool 100 to measure behavior of that component. The sensors 108 may also be coupled to the monitoring logic 114, which may receive signals from the sensors 108 and may be configured with logic to analyze the sensor signals for particular events in accordance with predetermined event conditions. These predetermined event conditions may be stored in a memory 116, coupled to the monitoring logic 114. In some embodiments, one or more of the sensors 108 may be coupled to the memory 116, and the memory 116 may provide a buffer for signals from the sensors that may be contemporaneously or later processed by the monitoring logic 114. In some embodiments, one or more of the sensors 108 may be provided by a multi-purpose sensor system, such as that manufactured by and designed for the Arduino platform. In some embodiments, one or more of the sensors 108 may include a global positioning system (GPS) sensor or other location sensor (e.g., one based on Wi-Fi triangulation).

The tool 100 may include control logic 118. The control logic 118 may be coupled to the sensors 108, the monitoring logic 114, and/or the memory 116, and may also be coupled to the actuator 122. The control logic 118 may be configured to control the actuator 122 (and thereby control operation of the tool 100) in accordance with predetermined rules stored in the memory 116 and based on signals from the sensors 108 and/or the monitoring logic 114.

The actuator 122 may be coupled to a tool application interface 120, and may be configured to provide actuating forces to the tool application interface 120 to operate the tool (e.g., drive a nail or rivet). The actuator 122 may include conventional mechanical and electrical components to use energy received at the tool 100 via the actuation energy interface 138 to cause the tool application interface 120 to perform its intended function. In some embodiments, the tool application interface 120 may come in contact with or otherwise act on a workpiece 102. The workpiece 102 may be, for example, a framing stud, a part being manufactured on an assembly line, or any other component on which the tool 100 is to operate.

In some embodiments, the tool application interface 120 may be coupled with the sensors 108. In particular, one or more of the sensors 108 may be included in the tool application interface 120. For example, a nail gun may have a safety sensor (mechanical or electrical) on the nose piece that detects when the nose piece is pressed against a workpiece (e.g., the workpiece 102). If the nose piece is not sufficiently pressed against a workpiece, the nail gun will not fire. In some such embodiments, the tool application interface 120 may include the nose piece, and a sensor 108 included in the tool application interface 120 (e.g., a pressure sensor or mechanical switch) may send a signal to the monitoring logic 114 and/or the control logic 118. The signal may be representative of whether the nose piece is pressed against a workpiece (e.g., a binary signal or a signal having continuous or more than two discrete values), and may be used by the monitoring logic 114 and/or the control logic 118 in various ways. For example, the monitoring logic 114 may record (e.g., in the memory 116) an attempt by a user to pull the trigger of the nail gun when the nose piece is not sufficiently pressed, and this information may be reported (via the communication interface 132) to the remote monitoring device 106 so that the user's manager can track these attempts as a potential safety violation. The control logic 118, in response to an attempt by a user to pull the trigger of the nail gun when the nose piece is not sufficiently pressed (as detected by the appropriate sensor), may prevent the actuator 122 (e.g., a piston) from supplying an actuating force to the tool application interface 120 and thus prevent the firing of the nail gun.

In some embodiments, the tool 100 may include a clock 112. The clock 112 may be coupled to the monitoring logic 114 and/or the control logic 118 and may provide time and date information. The monitoring logic 114 and/or the control logic 118 may use the time and date information provided by the clock 112 to timestamp signals received from the sensors 108 and/or events detected. In some embodiments, sensor signals and/or events may be stored in the memory 116 along with a timestamp to indicate the time at which the sensor signal was generated/received or the event detected.

The sensors 108, monitoring logic 114, and control logic 118 may serve any of a number of purposes. For example, a device (e.g., the tool 100) may be equipped with one or more sensors (e.g., the sensors 108 and supporting logic), which measure any of the following, as suitable:

1. Nails present in slide (e.g., the accessory supply 110 of the tool 100) and slide closed (ready to fire).

2. Proper size nails (e.g., in the accessory supply 110 of the tool 100).

3. Air pressure (e.g., measured at the actuation energy interface 138 of the tool 100) at minimum to operate gun successfully (ready to fire).

4. Nose piece (e.g., included in the tool application interface 120, discussed below) depressed (ready to fire).

5. Count of discharges throughout a period of time.

6. Depth of final set of nail (or resistance at firing head) (e.g., measured at the tool application interface 120, as discussed below).

7. Success of recent trigger pull (nail fired properly).

8. The orientation of the device (e.g., the tool 100).

9. The motion of the device (e.g., the tool 100).

10. More than one of the above.

In some embodiments, the above functionality may be provided by a combination of one or more sensors 108 and the monitoring logic 114. In some embodiments, sensing the above conditions (e.g., via the monitoring logic 114) may result in the control logic 118 causing the tool 100 to perform or not perform one or more actions.

As noted above, the sensors 108 included in the tool 100 may take any of a number of forms, and may depend on the type of tool 100, the power available to the tool 100, and the desired functionality of the tool 100. Sensors included in a device (e.g., the sensors 108 included in the tool 100) may include but are not limited to:

1. Optical sensors that “look” for a desired condition.

2. Accelerometers.

3. Magnetism.

4. Pressure using springs or levers.

5. Open/closed circuit.

6. More than one of the above.

A sensor may provide output to the data stream at all times, only when requested, only when the safety nose is depressed, or only when air pressure is present.

As noted above, in some embodiments, the sensors 108 may include one or more optical sensors. An optical sensor may include a detector configured to detect light incident on a surface of the detector and to output a signal (e.g., an electrical signal) representative of the amount of incident light. A detector of an optical sensor may be tuned to detect specific electromagnetic wavelengths or ranges of electromagnetic wavelengths, and/or may be configured to detect light that is incident on the surface at a particular angle or range of angles. In some embodiments, an optical sensor may include an emitter configured to emit light. The light emitted by an emitter may be at a specified electromagnetic wavelength or range of electromagnetic wavelengths, and may be emitted at a particular angle or range of angles. In some embodiments, the emitter and the detector of an optical sensor may form an emitter-detector pair in that the emitter and detector are configured so that the wavelengths of light emitted by the emitter are detectable by the detector. The emitter-detector pair of an optical sensor may be arranged in the tool 100 so that, when light emitted by the emitter is detected by the detector, this detection is representative of some behavior of interest of the tool 100. For example, the emitter and detector of an emitter-detector pair may be arranged in the tool 100 “facing each other” so that the detector will detect the greatest amount of light emitted toward the detector from the emitter when the emitter and the detector are aligned in a predetermined manner. In another arrangement, the emitter and detector of an emitter-detector pair may be arranged in the tool 100 “next to each other” so that the detector will detect light emitted from the emitter after it has been reflected back to the detector by another surface. These arrangements are simply examples, and emitter-detector pairs may take any suitable form. Any suitable optical sensor, such as any of the commercially available optical sensors, may be used in accordance with suitable ones of the embodiments disclosed herein. Example embodiments of the tool monitoring/control system 150 including optical sensors are discussed in further detail below.

As noted above, in some embodiments, the sensors 108 may include one or more magnetic sensors. A magnetic sensor may include a detector configured to detect a magnetic field proximate to the detector and to output a signal (e.g., an electrical signal) representative of the strength of the magnetic field. In some embodiments, the detector may itself be a magnet. In some embodiments, a magnetic sensor may include a pair of magnets, and this pair of magnets may be arranged in the tool 100 so that, when one magnet detects the magnetic field generated by the other magnet, this detection is representative of some behavior of interest of the tool 100. For example, since the strength of a magnetic field between two magnets is generally inversely proportional to the square of the distance between them, a magnetic sensor may detect changes in the proximity of two permanent magnets by detecting changes in the strength of the magnetic field between them. These arrangements are simply illustrative examples, and magnetic sensors may take any suitable form. Any suitable magnetic sensor, such as any of the commercially available magnetic sensors, may be used in accordance with suitable ones of the embodiments disclosed herein. Example embodiments of the tool monitoring/control system 150 including magnetic sensors are discussed in further detail below.

As noted above, in some embodiments, the sensors 108 may include one or more accelerometers. An accelerometer may be configured to measure the acceleration of a body to which it is attached, in one, two, or three directions, and to output a signal (e.g., an electrical signal) representative of the acceleration. Accelerometers that measure acceleration in one direction may be referred to as “linear accelerometers,” and accelerometers that measure acceleration in two or more directions may be referred to as “multi-axis accelerometers.” A multi-axis accelerometer may output a signal having multiple components, corresponding to the accelerations along the multiple axes. Any suitable accelerometer, such as any of the commercially available accelerometers, may be used in accordance with suitable ones of the embodiments disclosed herein. Example embodiments of the tool monitoring/control system 150 including an accelerometer are discussed in further detail below.

In some embodiments, accelerometers may permit the user to interface with the tool by moving it. For example, a safety feature may be automatically engaged or disengaged depending on the position of the tool. A user may engage the safety by shaking the tool or pointing it upward. In some embodiments, the sensors 108 may include an accelerometer configured in accordance with any of the foregoing embodiments.

Sensors may require use of conductive/non-conductive parts or magnetic/non-magnetic parts, for proper functionality. For example, some sensor configurations may be contact sensors that use open/closed circuit loops to determine the status of a portion of a tool. In some such embodiments, if the element that is to open/close the circuit is non-conductive, the sensing mechanism will not work (e.g., if the metal of a nail is used to complete a circuit to sense the presence of the nail, use of non-conductive nails may prevent the sensing circuit from properly functioning). Similarly, if a sensor is intended to operate with a magnetic component, use of a non-magnetic material for that component may complicate the performance of the sensor. Manufacturers may specify these constraints on the packaging of the tool, and may choose sensing systems to accommodate the range of materials typically used with that tool (e.g., the type of metal used in nails for a nail gun and the collation that holds the nails together prior to use in the nail gun).

Storage of data (e.g., from the sensors 108 and/or the monitoring logic 114, and in the memory 116) may be for short term (e.g., data field “reset” after each fire), medium term (e.g., data field “reset” at each air pressure hookup, e.g., at each use, or daily or other), and long term (e.g., no “reset” throughout the life of the gun, or only at a maintenance interval) or some combination.

The tool 100 may include a communication interface 132. The communication interface 132 may include any hardware suitable for communicating data between the tool 100 and a signal source 104, and/or between the tool 100 and a remote monitoring device 106. In some embodiments, the communication interface 132 may include a receiver/transmitter 134, which may provide the tool 100 with wired and/or wireless communication functionality (e.g., via one or more network interface cards, antennas, power amplifiers, and other communication circuitry). In some embodiments, the communication interface 132 may support one or more wireless communication protocols, such as Bluetooth, Zigbee, Wi-Fi, radio frequency identification (RFID) mechanisms, wireless cellular protocols (such as 3G), or any other suitable short-, medium-, or long-range wireless communication protocol. In some embodiments, the communication interface 132 may support one or more wired communication protocols, such as peripheral component interconnect (PCI) protocols, universal serial bus (USB) protocols, or any other suitable wired communication protocol. In some embodiments in which the tool 100 has pneumatic functionality and includes an air hose coupled to the actuation energy interface 138, a communication cable (coupled to the communication interface 132) or electrical energy cable (coupled to the actuation energy interface 138) may be bundled with or run alongside the air hose.

In some embodiments, the communication interface 132 may be coupled with the sensors 108, the monitoring logic 114, and/or the memory 116, and may be configured to transmit data from any of these data sources to the remote monitoring device 106. The remote monitoring device 106 may be any suitable computing device, such as a smartphone, a tablet, a server, a laptop, a desktop computer, or any other computing device configured for communication with the tool 100 via the communication interface 132. In some embodiments, the communication interface 132 may be coupled with the memory 116, and may be configured to receive data from one or more signal sources 104 and/or the remote monitoring device 106 and to store this data in the memory 116. In some embodiments, the signal source 104 may include a radio frequency (RF) transmitter or other RFID device configured to provide data accessible to the tool 100 via the communication interface 132. For example, the signal source 104 may be an RFID chip included in an employee's name tag, and the communication interface 132 may be configured to detect employee identification data stored in the RFID chip and provide this data to the memory 116 for storage (e.g., as indicative of the employee using the tool 100).

Short-term storage may be accomplished without a storage mechanism (e.g., without the use of an on-board memory 116), as data may be expressed immediately through output, requiring no reset or storage. In some embodiments, this output may be accomplished by transmitting the data through the communication interface 132 to the remote monitoring device 106 (or any other suitable device) and/or by presenting the data to the user of the tool 100 through the audio interface 126, the visual interface 128, and/or the tactile interface 130, as discussed in detail below.

Storage (e.g., of data generated by the sensors 108 and/or the monitoring logic 114) may also be accomplished through a circuit board that uses random access memory (RAM) or Flash or another memory type (non-disc drive) and allows for data to be held until ready for expression, or to use more than one piece of data to express one piece of data (e.g., nails present an air pressure above minimum as input, gun ready to fire as output). A logic circuit (e.g., included in the monitoring logic 114 and/or the control logic 118) may be used to merge or diverge this data to various output schemes. For medium- and long-term storage, a method of reset may be provided (e.g., upon disconnecting an air hose, via a button on an assembly, a switch, etc.).

As noted above, the tool 100 may include one or more interfaces for providing information to a user of the tool 100 and/or for receiving information (e.g., operation instructions) from the user. In FIG. 1, these interfaces are represented as the audio interface 126, the visual interface 128, and the tactile interface 130.

The audio interface 126 may include suitable hardware for providing audio information to a user of the tool 100. Examples of such hardware may include speakers, buzzers, text-to-voice translators, memory to store predetermined warning messages and sounds, and known driver and control hardware. In some embodiments, the audio interface 126 may be coupled to the monitoring logic 114 and/or the control logic 118, and the audio interface 126 may be configured to provide audio information to the user based on events detected by the monitoring logic 114 and/or the control logic 118. Examples of such audio information may include warning messages, audible indicators of various malfunctions, and tones to signify various events. As noted above, the audio interface 126 may be utilized for receiving audio information from a user of the tool 100 (e.g., instead of or in addition to providing audio information). For example, in some embodiments, the audio interface 126 may be configured with voice recognition or other audio recognition logic in order to receive verbal or other audible commands from a user. Some applications may be less suitable for sensitive voice and audio recognition techniques (e.g., when the tool 100 will be used in a loud setting).

Audio outputs may not be suitable for users in some settings. For example, users of tools in manufacturing facilities often wear hearing protection, and thus may not be able to hear many kinds of sounds generated by the audio interface 126. In some embodiments, the audio interface 126 may be coupled via a wireless connection (e.g., via the communication interface 132) to a set of headphones worn by the user of the tool 100 (e.g., included in the user's hearing protection), and may provide audio information directly to the user's ears, bypassing the blocking effect of the hearing protection.

The visual interface 128 may include suitable hardware for providing visual information to a user of the tool 100. Examples of such hardware may include lights (e.g., light emitting diodes (LEDs)), numeric or alphanumeric displays, touch pads, or other hardware that can provide visual information to a user. In some embodiments, the visual interface 128 may be coupled to the monitoring logic 114 and/or the control logic 118, and the visual interface 128 may be configured to provide visual information to the user based on events detected by the monitoring logic 114 and/or the control logic 118. Examples of such visual information may include visual indicators (e.g., text or graphic messages) representative of any suitable ones of the sensor conditions discussed above (e.g., “no nails present in slide”), warnings, indicators of various malfunctions, or any other suitable information. As noted above, the visual interface 128 may be utilized for receiving visual information from a user of the tool 100 (e.g., instead of or in addition to providing visual information). For example, in some embodiments, the visual interface 128 may be configured with one or more cameras and logic to determine if the environment imaged by the cameras is different from an environment in which the tool 100 is intended to be used (e.g., to determine if the tool 100 has been stolen from a job site and taken to a user's home).

Various types of visual information may be more or less suitable for users in various settings. For example, sensitive touch screens may be inappropriate in industrial or other heavy use environments because they are likely to be damaged. Visual information should also be readily perceived by a user of the tool 100, and thus should be presented in a format that will catch the user's eye in an appropriate manner. For example, a user may readily see, with his or her peripheral vision, a color change in a warning light mounted on the back of the nail gun. If that color change is associated with a known condition (e.g., “no nails present in slide,” detected via the sensors 108 and the monitoring logic 114), the user may be able to quickly stop what he or she is doing and attend to the condition.

The tactile interface 130 may include suitable hardware for providing tactile information (e.g., haptic information) to a user of the tool 100. Examples of such hardware may include vibrating components or other hardware that can provide tactile information to a user. In some embodiments, the tactile interface 130 may be coupled to the monitoring logic 114 and/or the control logic 118, and the tactile interface 130 configured to provide tactile information to the user based on events detected by the monitoring logic 114 and/or the control logic 118. Examples of such tactile information may include various types of vibrations or other changes in the “feel” of the tool 100 that are representative of any suitable ones of the sensor conditions discussed above (e.g., “no nails present in slide”), warnings, indicators of various malfunctions, or any other suitable information.

For example, in some embodiments, the tactile interface 130 may include a vibration device seated in a handle of the tool 100. The vibration device may be coupled to the control logic 118; when the control logic 118 determines that the actuator 122 should be prevented from firing a nail because of one or more error conditions, the control logic 118 may cause the vibration device to vibrate, signaling to the user that something is wrong before the user attempts to fire another nail. Vibration type alerts should be chosen to be sufficiently distinct from vibrations commonly experienced when using the tool 100, and should be strong enough to be detected through work gloves without causing undue surprise to the user. Tactile feedback may be particularly important to novice users of the tool 100, who may not have the experience to know when the tool 100 is being properly used “by feel.”

As noted above, the tactile interface 130 may be utilized for receiving tactile information from a user of the tool 100 (e.g., instead of or in addition to providing tactile information). For example, the tactile interface 130 may include one or more buttons, knobs, or other input devices that a user can actuate to signal various kinds of information or commands to the tool 100. When the tool 100 is a nail gun, the tactile interface 130 may include the trigger that causes a nail to be driven from the nail gun. In some embodiments, the tactile interface 130 may include a button (e.g., a momentary or non-momentary switch) that may be depressed or toggled by a user to signal to the tool 100 that a subsequent actuation of the tool 100 (e.g., a subsequent driving of a nail) or a subsequent positioning of the tool 100 is for calibration of one or more of the sensors 108 and/or the monitoring logic 114. Examples of such embodiments are discussed in further detail below. The tactile interface 130 may also include a touch screen or other non-button input devices.

As noted above, output/expression/feedback of data may take various forms, and can include but is not limited to:

1. An LED or other light type that uses a system of colors, flashes, or combination of lights to indicate simple forms of data (gun ready to fire, or is out of nails) (e.g., via the visual interface 128 of the tool 100). More data output will require more lights or other visual output options.

2. A screen that lists a code, an indication term (START, FINISH, READY, etc.), or an icon or other illustration (e.g., via the visual interface 128 of the tool 100).

3. Haptic feedback through the handle (e.g., via the tactile interface 130).

4. Any other suitable mechanism for providing an indicator to a user.

5. More than one of the above.

Each type of output has limitations that the others may overcome, and therefore more than one may be used. In various embodiments, combinations of types of output may be used as appropriate for particular settings and tools.

Electricity (e.g., stored in the electrical power supply 124) can be used to provide other functionality, such as devices that aid users in positioning the tool, such as lights, or indicators of tool position, such as levels. A tool with sensors (e.g., the sensors 108 of the tool 100) that provide feedback on tool position may be used to ensure, for example, that a series of nails is driven into a substrate at a consistent angle. Examples of some such embodiments are discussed below. In some such embodiments, the monitoring logic 114 records the angle at which a nail is driven into the workpiece 102 (e.g., in the memory 116) and may provide a summary of this information to the user of the tool 100 and/or to the remote monitoring device 106 that the user's manager can use to monitor the user's performance.

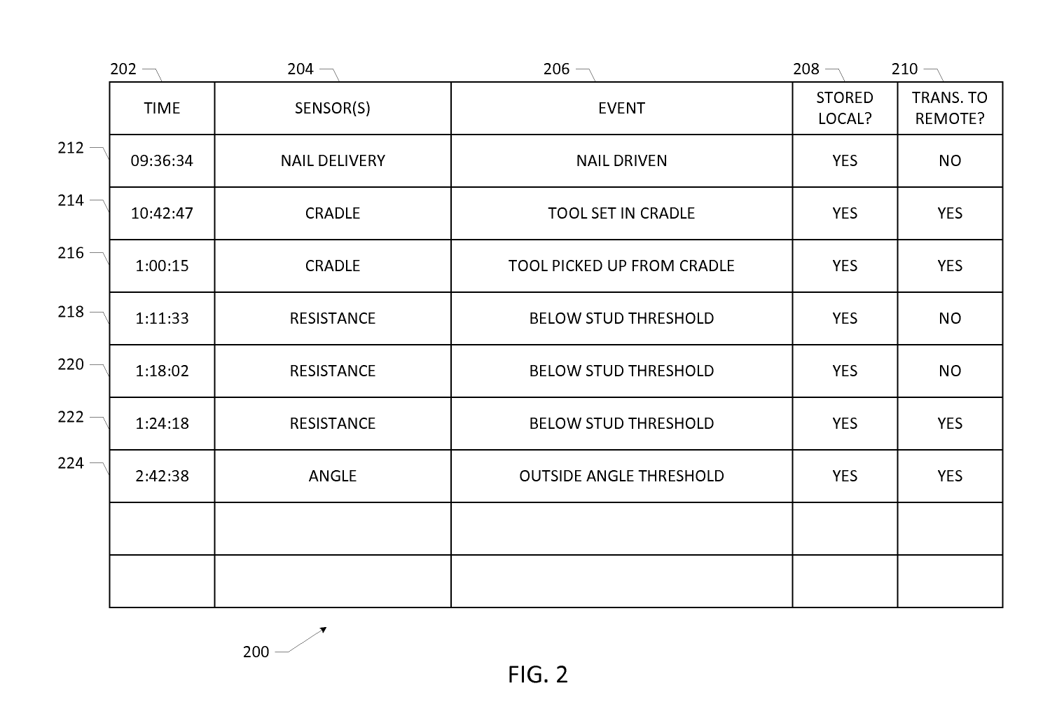

FIG. 2 depicts a memory structure 200 that may be stored in the memory 116 and used to store information generated by the sensors 108, the monitoring logic 114, and/or the control logic 118. The memory structure 200 includes a timestamp field 202 (to store a timestamp of the associated entry), a sensors field 204 (to store indicators of which sensors are associated with the entry), an event field 206 (to store an indicator of the event associated with the entry), a local storage field 208 (to store an indicator of whether information about the entry is stored locally to the tool 100), and a remote transmission field 210 (to store an indicator of whether information about the entry has been transmitted to the remote monitoring device 106). The memory structure 200 includes a number of example entries 212-224, indicating various types of events that may be stored in the memory 116. The data shown in the memory structure 200 of FIG. 2 is simply illustrative, and any suitable data may be stored in any suitable format.

The following paragraphs describe a number of embodiments of the tool 100. These embodiments may be implemented singly or in any combination in a tool 100 as desired and suitable for particular applications. For example, the functionality suitable for particular embodiments of the tool 100 may be based on the amount of power available on the tool 100. As such, when more power is available, functionalities that demand higher power (e.g., GPS receivers) may be implemented. When less power is available, functionalities that require less power may be suitably implemented.

In some embodiments, data collected by the monitoring logic 114 and/or the control logic 118 (and stored in the memory 116 or transmitted to the remote monitoring device 106 via the communication interface 132) may be used as part of an employee performance monitoring program. Employee performance can be difficult to quantify, especially at a distributed job site (e.g., a large construction site) or when there are many employees to monitor (e.g., a dense assembly line). For example, unless an employee is being directly supervised, it can be difficult to tell if the employee has been taking extra breaks, slowing the pace of work below an acceptable level, using the tools correctly, following safety rules, and starting and ending his or her workday on time. In some settings, an employee must stop work when his or her tool malfunctions; thus, employees seeking an extra break may report that the tool “just stopped working” or experienced another malfunction. However, these employee reports may not always be truthful; the employee may have deliberately mishandled the tool. When an employee is responsible for the condition of his or her tools, he or she may not wish to admit when a tool has been dropped or mishandled, and thus may falsely report (or fail to report) a malfunction. Direct supervision of every employee is not a cost-effective solution, nor is it comfortable for many employees.

In some embodiments, data collected by the monitoring logic 114 and/or the control logic 118 (and stored in the memory 116 or transmitted to the remote monitoring device 106 via the communication interface 132) may be used as part of an inventory management program. The cost of servicing, repairing, and replacing tools can be a significant expense for certain kinds of companies (e.g., those in the construction and manufacturing industries). In some companies, tools are serviced on a predetermined schedule based upon the tool manufacturer's estimate of wear-and-tear for certain amounts of use (analogous to the automobile “checkups” scheduled at predetermined mileage intervals). However, the actual wear-and-tear on a tool may vary dramatically from the manufacturer's estimate, and thus it is likely that many tools are serviced too “early” and that many tools are serviced too “late.” Additionally, the wear-and-tear on a tool may be heavily determined by how that tool is used. Tool usage may be quantified by the amount of normal operation (e.g., for a nail gun, the number of nails driven), but also the conditions of operation (e.g., the resistance of the material into which the nails are driven, the angle at which the nails are driven) and operator behavior (e.g., dropping the tool, dry firing the tool, or running the tool too hot). Additionally, tools may be taken out of operation and inspected in response to an employee report that the tool “just stopped working” or experienced another malfunction. However, as noted above, these employee reports may not always be truthful; the employee may have in fact dropped the tool or otherwise mishandled it. In addition to the expense of tool maintenance, the cost to a business of taking a tool “off the line” may be even more significant.

The following embodiments illustrate a number of examples of functionalities for which the tool 100 may be configured to be suitable for use in an employee monitoring program, an inventory management program, or both. These programs are simply illustrative applications of the embodiments below, and the embodiments below may be applied in any suitable setting in any combination.

In some embodiments, the tool 100 may be configured to measure (e.g., via the sensors 108 and the monitoring logic 114) and transmit (e.g., via the communication interface 132) data representative of user productivity to the remote monitoring device 106. For example, the data may be representative of the amount of use of the tool 100. The amount of use may be measured in terms of number of actuation cycles in a predetermined interval (e.g., the number of nails driven) or the number of actuation cycles in a predetermined interval in which the tool 100 was properly oriented (e.g., discounting nails driven at improper angles). This transmission of data may occur at regular intervals or in response to a request from the remote monitoring device 106, for example. In some embodiments, this information may not be transmitted to any remote monitoring device, and may instead be accessible to the user of the tool 100 via the visual interface 128 exclusively. Such an embodiment may be particularly appropriate for home use, in which a non-professional user may be interested in monitoring the number of nails he or she drove in a given day. In some embodiments, the remote monitoring device 106 may be owned by the user of the tool 100, and may collect data on use of the tool 100 and display that data for the user 100. For example, the remote monitoring device 106 may be a smartphone owned by the user of the tool 100, and may provide a visual display of the amount of use of the tool 100 (e.g., tracked over time). The user may be able to forward this information to his or her contacts, or allow his or her contacts to otherwise access this information.

In one example, the tool 100 may be configured to measure and transmit data representative of the quality of user work with the tool 100 to the remote monitoring device 106. For example, when the tool 100 is a nail gun, and the user of the tool 100 is supposed to be mounting plywood to framing studs at a construction site, a resistance sensor included in the sensors 108 may measure the resistance experienced by a nail driven by the tool 100 and provide that resistance to the monitoring logic 114. The monitoring logic 114 may be configured to determine whether the amount of resistance indicates that the nail was driven into approximately 3 or more inches of wood (indicating proper placement in a mounting stud) or into a smaller amount of wood (e.g., one half inch of wood, indicating that the nail was fired into the plywood but missed the stud, and thus was improperly driven).

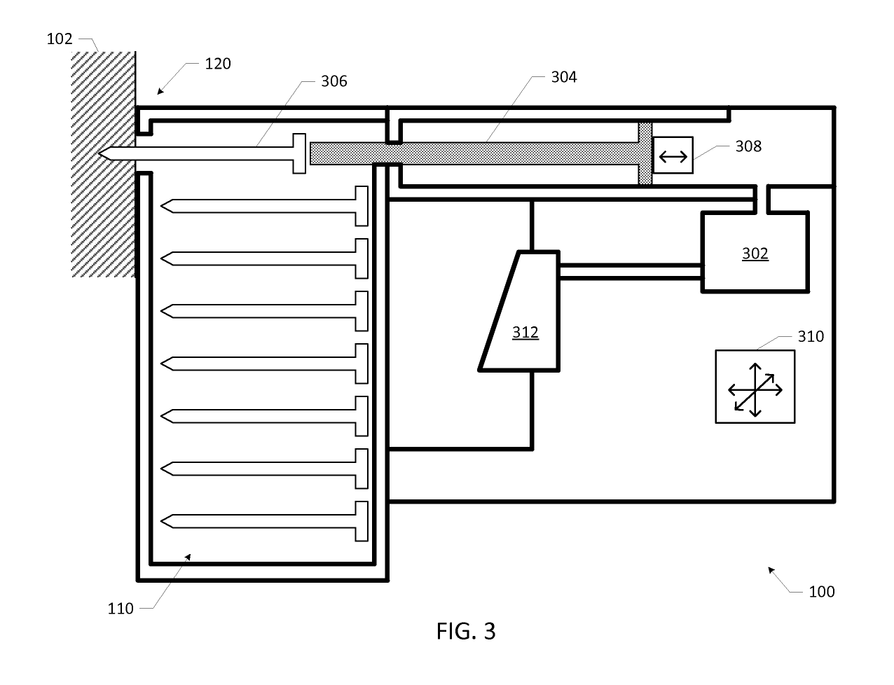

Such a resistance sensor may take any of a number of forms. FIG. 3 schematically illustrates an example of an embodiment in which the tool 100 is a nail gun that includes a resistance sensor for determining whether a nail was properly driven. In particular, FIG. 3 schematically illustrates various components of a nail gun 100 (an example of the tool 100) as a nail 306 is driven into a workpiece 102, in accordance with various embodiments. The nail gun 100 may include an accessory supply 110 that supplies nails to the nail gun 100, and a piston 304 that drives the nail 306 into the workpiece 102. In the embodiment illustrated in FIG. 3, actuation of the trigger 312 by the user of the nail gun 100 may cause a supply of compressed air contained in a compressed air storage unit 302 to be released behind the piston 304, driving the piston 304 into the nail 306 and driving the nail 306 into the workpiece 102. In other embodiments of the nail gun 100, a non-pneumatic driving system may be used, as known in the art.

As schematically illustrated in FIG. 3, an accelerometer 308 may be mounted on the piston 304. Although the accelerometer 308 is illustrated in FIG. 3 as located at the end of the piston 304, the accelerometer 308 may be located at any suitable location (e.g., along the length of the piston 304). In some embodiments, the accelerometer 308 may be a linear accelerometer, arranged to detect acceleration of the piston 304 along the longitudinal axis of the piston 304. In particular, the accelerometer 308 may provide an output signal representative of the acceleration of the piston 304 (along the longitudinal axis of the piston 304) as a function of time, and therefore may signal changes in the acceleration of the piston 304 as the piston 304 drives the nail 306 into the workpiece 102.

When the amount of compressed air released from the compressed air storage unit 302 in response to a pull of the trigger 312 is approximately the same between subsequent trigger pulls, the amount of force imparted on the piston 304 by the compressed air will be a known, constant quantity. However, as discussed above, the resistance experienced by the nail 306 as it is driven into the workpiece 102 may vary depending on the material into which the nail 306 is driven and the thickness of that material, among other variables. If a user is driving nails into studs of known composition and thickness, the amount of resistive force experienced by the nail 306 as it is driven will likely be a relatively constant quantity that is readily determined. For example, the nail gun 100 may be calibrated with the expected resistive force by pressing a button or otherwise signaling to the nail gun 100 that a predetermined number of the subsequent drivings of nails are to be used for calibration purposes, and having the user properly drive this predetermined number of nails while the acceleration is monitored by the monitoring logic 114.

Since the acceleration of the piston 304 is a function of the difference between the driving forces exerted by the compressed air (pushing the piston 304 towards the nail 306) and the resistive forces experienced by the nail 306 as it is driven into the workpiece 102 (pushing the piston 304 “back”), and since the former quantity is known, the latter quantity may be determined by measuring the acceleration of the piston 304 as the nail 306 is driven (using the known relationship F=ma). The greater the acceleration of the piston 304 as the nail 306 is driven into the workpiece 102, the less the resistance experienced by the nail 306 during the driving. The monitoring logic 114 (which may be calibrated to “expect” a certain amount of resistive force for a properly driven nail) may thus monitor the acceleration of the piston 304 for accelerations that exceed a threshold beyond what is expected for proper use, indicating that the nail 306 has been driven with “low” resistance and thus likely missed the stud.

Although the foregoing example focused on an application in which a decrease in resistance signaled an improper driving, an increase in resistance may also signal an improper driving (e.g., when a nail is driven into another nail, or into concrete, instead of into a stud, as desired). The monitoring logic 114 may be configured to detect such changes in addition to or instead of decreases in resistance.

In some embodiments, an angle sensor included in the sensors 108 may measure the angle between the axis on which a nail is driven in the surface of the workpiece 102 and a reference axis, and provide that angle to the monitoring logic 114. The monitoring logic 114 may be configured to determine whether the angle falls outside an acceptable margin around a desired angle (e.g., 90 degrees), and thus was improperly driven (and may result in missing the workpiece 102, reducing the holding power of the nail, and creating a safety hazard).

Such an angle sensor may take any of a number of forms. For example, the nail gun 100 of FIG. 3 is illustrated as including a multi-axis accelerometer 310. The multi-axis accelerometer 310 may be a three-dimensional accelerometer, and may output a signal indicative of the acceleration of the nail gun 100 in each of three orthogonal directions. Such a signal may be used, for example, to determine the orientation of the nail gun 100 in space due to the forces exerted by gravity, as known in the art. In some embodiments, the nail gun 100 may include an input device (e.g., a button) that the user may use to indicate that a subsequent positioning of the nail gun 100 is for calibration of the accelerometer 310 or the monitoring logic 114 so that the accelerometer 310 or the monitoring logic 114 uses a particular orientation as a reference point for subsequent driving of nails. In particular, the user may hold the nail gun 100 in a desired orientation with respect to a workpiece (e.g., the workpiece 102), and may use the input device to signal to the nail gun 100 that this orientation is the desired one for subsequent driving of nails. The monitoring logic 114 may store the data from the multi-axis accelerometer 310 during a calibration window after the signal from the user, and may use that data to identify a reference angle against which the position of the nail gun 100 during subsequent drivings may be evaluated. If the angle at which the nail gun 100 is held during subsequent drivings deviates from the reference angle by more than a threshold amount, the monitoring logic 114 may determine that a nail has been driven at an improper angle. Such an embodiment may be particularly advantageous when nails are not intended to be driven at a right angle to a workpiece, because any desired reference angle may be used.

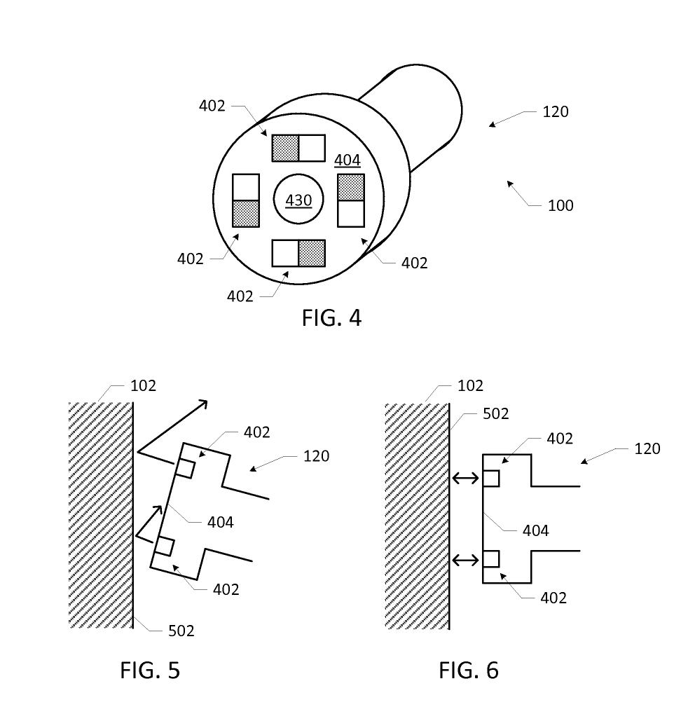

Another example of an angle sensor configuration is illustrated in FIGS. 4-6. In particular, FIG. 4 is a perspective view of a portion of a nose piece 120 (serving as the tool application interface) of a nail gun 100 having multiple optical sensors 402, and FIGS. 5-6 are side views of the operation of the nail gun 100 of FIG. 4 when the nose piece 120 (an example of the tool application interface 120) of the nail gun 100 is oriented at different angles with respect to a workpiece 102. Each optical sensor 402 may include an emitter-detector pair arranged side-by-side. The optical sensors 402 may be arranged in a common plane of a face 404 of the nose piece 120, and around the aperture 430 from which nails are ejected from the nail gun 100. Although four optical sensors 402 are shown, this number is simply illustrative, and any desired number (e.g., two or more) may be used.

As illustrated in FIGS. 5 and 6, during use, light may be emitted from the emitters of the optical sensors 402, which may reflect off the surface 502 of the workpiece 102. When the face 404 of the nose piece 120 is not oriented parallel to the surface 502 of the workpiece 102 (as shown in FIG. 5), light emitted from the emitters of the optical sensors 402 may reflect off the surface 502 in directions away from the detectors of the optical sensors 402; as a result, the incident light signals from the detectors may be small and/or may be significantly different between different ones of the optical sensors 402. When the face 404 of the nose piece 120 is oriented approximately parallel to the surface 502 of the workpiece 102 (as shown in FIG. 6), light emitted from the emitters of the optical sensors 402 may reflect off the surface 502 and back towards the detectors of the optical sensors 402; as a result, the incident light signals from the detectors may be large and/or may be substantially the same between different ones of the optical sensors 402. Thresholds for how much deviation from “parallel” will be tolerated may be calibrated into the monitoring logic 114, which may apply these thresholds to determine when a nail is driven at an angle that deviates too much from perpendicular to the surface 502. In some embodiments, each of the optical sensors 402 included in the nose piece 120 may use a different wavelength or range of wavelengths to reduce “cross-contamination” between the optical sensors 402.

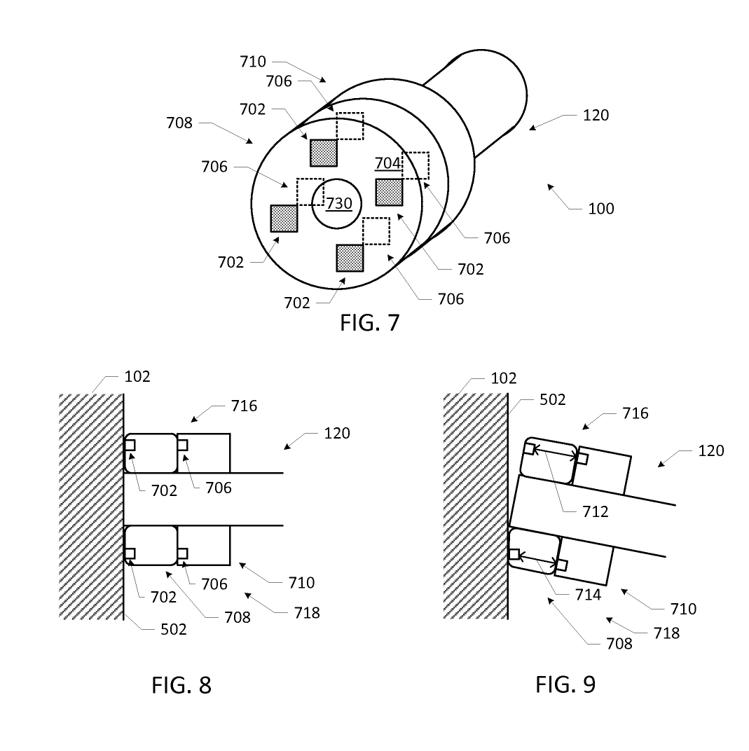

Another example of an angle sensor configuration is illustrated in FIGS. 7-9. In particular, FIG. 7 is a perspective view of a portion of a nose piece 120 (serving as the tool application interface) of a nail gun 100 having multiple magnetic sensors, and FIGS. 8-9 are side views of the operation of the nail gun 100 of FIG. 7 when the nose piece 120 of the nail gun 100 is oriented at different angles with respect to a workpiece 102. Each magnetic sensor may include a pair of magnets 702 and 706. The magnets 702 may be embedded in or otherwise positioned on a face 704 of a first portion 708 of the nose piece 120, and the magnets 706 may be embedded in or otherwise included in a second portion 710 of the nose piece 120. The first portion 708 of the nose piece 120 may be formed from an elastic material, such as a rubber. In particular, when the first portion 708 of the nose piece 120 is pressed against the surface 502 of the workpiece 102 (e.g., as shown in FIG. 9), the first portion 708 of the nose piece 120 may deform. The second portion 710 of the nose piece 120 may be formed from a substantially inelastic material, such as metal or a hard plastic. When the first portion 708 of the nose piece 120 deforms under contact with the surface 502, the second portion 710 may not substantially deform. The position of the magnets 702 and 706, and the choice of the materials for the first portion 708 and the second portion 710, may be selected so that, when the nose piece 120 is pressed against the surface 502, the spacing between the magnet 702 and the magnet 706 of each magnetic sensor will change. For example, FIG. 9 illustrates a scenario in which the magnets 702 and 706 of the magnetic sensor 716 are spaced apart by a distance 712 (corresponding to the spacing of the magnets 702 and 706 when the first portion 708 of the nose piece 120 is locally undeformed), but the magnets 702 and 706 of the magnetic sensor 718 are spaced by a distance 714, less than the distance 712, as a result of the deformation of the first portion 708 of the nose piece 120 locally to the magnetic sensor 718.

The magnets 702 may be arranged in a common plane of a face 704 of the nose piece 120, and around the aperture 730 from which nails are ejected from the nail gun 100. The magnets 706 may be arranged in a common plane in the second portion 710 of the nose piece 120, although any spacing may be used as long as it is predetermined and calibrated for by the monitoring logic 114. Although four magnets 702 and four corresponding magnets 706 are shown, this number is simply illustrative, and any desired number (e.g., two or more) may be used.

As illustrated in FIGS. 8 and 9, when the face 704 of the nose piece 120 is oriented approximately parallel to the surface 502 of the workpiece 102 (as shown in FIG. 8), any deformation of the first portion 708 of the nose piece 120 may move the magnets 702 toward the second portion 710 substantially uniformly. Consequently, the magnetic fields detected by the magnets 706 may be substantially the same. When the face 704 of the nose piece 120 is not oriented parallel to the surface 502 of the workpiece 102 (as shown in FIG. 9), the first portion 708 of the nose piece 120 may deform non-uniformly, causing the separation between the magnets 702 and 706 in certain magnetic sensors to be different than the separation between the magnets 702 and 706 in other magnetic sensors. Consequently, the magnetic fields detected by the magnets 706 may not be substantially the same. Thresholds for how much deviation from “parallel” will be tolerated may be calibrated into the monitoring logic 114, which may apply these thresholds to determine when a nail is driven at an angle that deviates too much from perpendicular to the surface 502.

Data representative of the number of properly and improperly driven nails (e.g., a percentage) may be displayed for the user of the tool 100 (e.g., via the visual interface 128) and/or may be transmitted to the remote monitoring device 106. In some embodiments, the tool 100 may be configured to indicate to the user when a nail has been improperly driven (e.g., via one of the interfaces 126-130) so that the user can immediately take corrective action. In some such embodiments, a light may flash, a buzzer may sound, or the tool 100 may vibrate to indicate to a user that a stud has been missed. In some embodiments, the remote monitoring device 106 may alert a manager (e.g., via a display included in the remote monitoring device 106) when a predetermined threshold of improperly driven nails has been reached (e.g., a threshold percentage or absolute number) so that the manager can intervene with the employee.

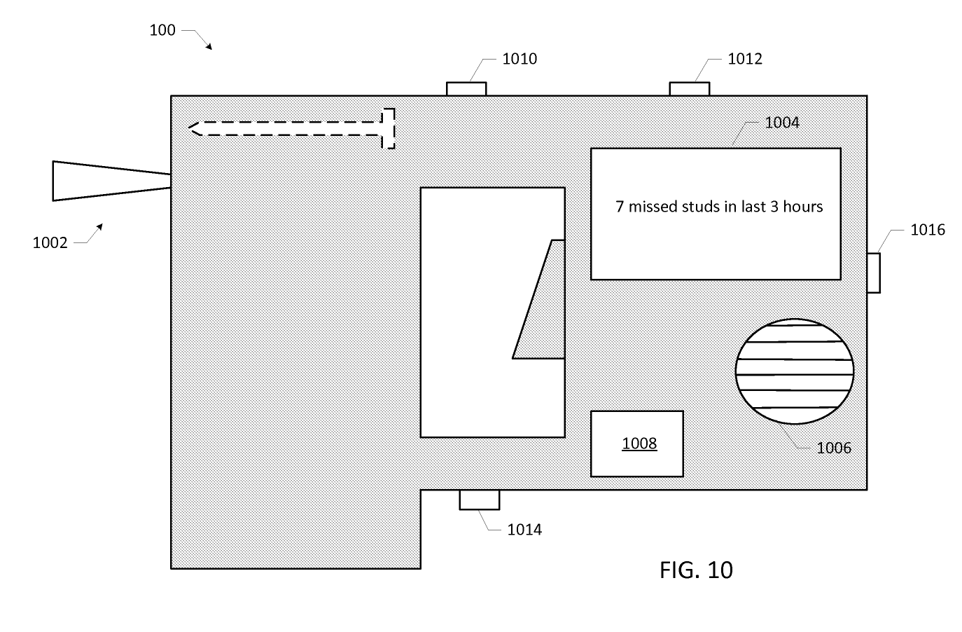

For example, FIG. 10 schematically illustrates various output interface components that may be included in a nail gun 100, in accordance with various embodiments. These output interface components may provide tool performance information to a user of a tool. Although a number of such components are illustrated in FIG. 10, a subset of these components may be used, or alternative components may be used, in accordance with the embodiments disclosed herein.

The nail gun 100 of FIG. 10 may include one or more lights as part of the visual interface 128. FIG. 10 illustrates four lights 1010, 1012, 1014, and 1016 disposed at different locations on an exterior casing of the nail gun 100. In particular, the lights 1010 and 1012 may be located on the “top” of the exterior casing of the nail gun 100, the light 1014 may be located on the “bottom” of the exterior casing of the nail gun 100, and the light 1016 may be located at the “back” of the exterior casing of the nail gun 100. Distributing multiple lights at different locations on the exterior of a tool may improve the ability of an operator of the tool to see the lights during use (e.g., by providing views of one or more lights from multiple locations relative to the tool). The lights included in the visual interface 128 may take any suitable form. For example, the lights included in the visual interface 128 may be LEDs. In some embodiments, the lights included in the visual interface 128 may include one or more multi-color LEDs that can illuminate at different colors.

In some embodiments, all of the lights 1010, 1012, 1014, and 1016 may be synchronized in that the light-emitting behavior of one of the lights is repeated by all of the lights. For example, all of the lights 1010, 1012, 1014, and 1016 may illuminate in response to a determination by the monitoring logic 114 that a predetermined event condition has been satisfied. This predetermined event condition may be related to a resistance experienced by a nail as it is driven, an angle at which a nail is driven, or any of the other conditions discussed herein. In some embodiments, all of the lights 1010, 1012, 1014, and 1016 may illuminate in a common color in response to a determination by the monitoring logic 114 that a particular alert condition has been satisfied, and may illuminate in a different common color in response to a determination by the monitoring logic 114 that a different alert condition has been satisfied (e.g., “red” for nail resistance and “blue” for nail angle). In other embodiments, different ones of the lights 1010, 1012, 1014, and 1016 may signal different information, and thus may not operate in synchronization. For example, one of the lights 1010, 1012, 1014, and 1016 may illuminate in response to a nail resistance condition, and a different one of the lights 1010, 1012, 1014, and 1016 may illuminate in response to a nail angle condition.

The nail gun 100 of FIG. 10 may include a graphical display as part of the visual interface 128. As illustrated in FIG. 10, a graphical display 1004 may be located on the exterior casing of the nail gun 100. The graphical display 1004 may be configured to display alphanumeric characters or graphical illustrations of the performance of the nail gun 100 (e.g., as determined by the monitoring logic 114). For example, as shown in FIG. 10, the graphical display 1004 may indicate to a user of the nail gun 100 that the user has missed 7 studs in the last 3 hours of operation (e.g., based on a nail resistance analysis, as discussed above).

The nail gun 100 of FIG. 10 may include a workpiece-illuminating light beam device as part of the visual interface 128. As illustrated in FIG. 10, a light beam device 1002 may be located proximate to the tool application interface 120 and arranged to illuminate a workpiece into which nails are to be driven. This light beam device 1002 may be capable of emitting light beams of multiple different colors, and in some embodiments, the color of light emitted by the light beam device may be selected by the visual interface 128 in response to a determination by the monitoring logic 114 that a predetermined event condition has been satisfied. This predetermined event condition may be related to a resistance experienced by a nail as it is driven, an angle at which a nail is driven, or any of the other conditions discussed herein. In some embodiments, the light beam device 1002 may emit a “white” light beam when no predetermined event condition is satisfied that requires immediate notification of the user of the nail gun 100, and may emit a “red” or other color of light beam when a predetermined event condition is satisfied. In some embodiments, the light beam device 1002 may emit light of a first color in response to a determination by the monitoring logic 114 that a particular event condition has been satisfied, and may emit light of a second color in response to a determination by the monitoring logic 114 that a different event condition has been satisfied (e.g., “red” for nail resistance and “blue” for nail angle).

The nail gun 100 of FIG. 10 may include a speaker as part of the audio interface 126. As illustrated in FIG. 10, a speaker 1006 may be arranged to emit one or more tones or other audible information to a user of the nail gun 100. Audible information may be emitted by the speaker 1006 in response to a determination by the monitoring logic 114 that a predetermined event condition has been satisfied. This predetermined event condition may be related to a resistance experienced by a nail as it is driven, an angle at which a nail is driven, or any of the other conditions discussed herein. In some embodiments, the audible signal emitted by the speaker 1006 may be the same regardless of the predetermined event condition, while in other embodiments, different audible signals may be emitted for different event conditions (e.g., playback of a recording of the word “miss” for nail resistance and the word “angle” for nail angle).

The nail gun 100 of FIG. 10 may include a vibration device as part of the tactile interface 130. As illustrated in FIG. 10, a vibration device 1008 may be arranged to vibrate at a particular frequency and with a particular magnitude in order to be detectable by a user of the nail gun 100 during use of the nail gun 100. The vibration device 1008 may vibrate in response to a determination by the monitoring logic 114 that a predetermined event condition has been satisfied. This predetermined event condition may be related to a resistance experienced by a nail as it is driven, an angle at which a nail is driven, or any of the other conditions discussed herein. In some embodiments, the frequency and/or magnitude of vibration may be the same regardless of the predetermined event condition, while in other embodiments, the frequency and/or magnitude of vibration may be different for different event conditions.

As noted above, in some embodiments, data representative of tool performance may be transmitted to the remote monitoring device 106. In some embodiments, the tool 100 may be configured to record the time at which the tool 100 is first operated in a workday and to transmit that information (e.g., via the communication interface 132) to the remote monitoring device 106. A manager with access to the remote monitoring device 106 may use this information to confirm that the employee started his or her workday on schedule. This may be particularly advantageous relative to the current use of timecard-based systems, in which an employee may “punch in” but then may linger before actually getting to work.

In some embodiments, the tool 100 may be configured to record the times at which actuation of the tool 100 drops below and/or exceeds a threshold (e.g., a number of uses in a predetermined interval) and to transmit that information (e.g., via the communication interface 132) to the remote monitoring device 106. The manager with access to the remote monitoring device 106 may use this information to determine that the employee is likely taking a break and/or that the employee's break has ended, and thus to confirm that the employee is taking breaks in accordance with the expected job schedule.

In some embodiments, the tool 100 may be configured to record the times at which the tool 100 is put down (e.g., via a pressure sensor in the base of the tool 100 that detects when the tool 100 is resting and/or a proximity sensor in the tool 100 that detects when the tool 100 has been replaced in a cradle or socket) and to transmit that information (e.g., via the communication interface 132) to the remote monitoring device 106. The manager with access to the remote monitoring device 106 may use this information to determine that the employee is likely taking a break or has paused work and/or that the employee's break or pause has ended, and thus to confirm that the employee is taking breaks or pauses in accordance with the expected job schedule.

As noted above, in some embodiments, the tool 100 may include a GPS device or other location sensor among the sensors 108. Information about the location of the tool 100 may be detected via the location sensors and transmitted to the remote monitoring device 106. The manager with access to the remote monitoring device 106 may use this information to determine whether the employee is in his or her proper location at the jobsite. For example, a general contractor or manager of a construction site may use his or her smartphone as the remote monitoring device 106, and may be able to determine, upon pulling up to a job site, where all of the workers are located via the locations of their tools.

In some embodiments, the tool 100 may be configured to record malfunctions (e.g., in the memory 116) and to transmit these malfunctions to the remote monitoring device 106 (e.g., upon request by the remote monitoring device 106, at predetermined intervals, or immediately upon detection). A manager with access to the remote monitoring device 106 may use this malfunction information to corroborate employee explanations for why work was paused or the tool 100 stopped working. For example, if an employee says that the tool 100 stopped working “for no reason,” and the monitoring logic 114 (based on a signal from an accelerometer included in the sensors 108) detected an acceleration pattern consistent with the tool 100 being dropped, the manager can further question the employee. Such information may alternatively or additionally be used to verify warranty claims; when a manufacturer has a tool returned for a purported manufacturer's error, the manufacturer may determine whether the tool was mishandled before honoring the warranty. In some embodiments, malfunctions may be detected and recorded locally on the tool 100 (e.g., in the memory 116) and the information may be displayed via the visual interface 128 upon proper access (e.g., pressing a predetermined set of keys on a keypad of the tool 100 or inserting a manager token into the tool 100).

In some embodiments, the tool 100 may be configured to control the actuation of the tool 100 in accordance with one or more predetermined safety rules included in the memory 116 and accessible by the control logic 118. For example, a predetermined safety rule may be that the tool 100 cannot be actuated when it is pointed at a human being. The tool 100 may include an infrared (IR) sensor or other suitable sensor in the sensors 108, the monitoring logic 114 may be configured to receive signals from the sensors and determine whether or not it is likely that a human being is within the “line of fire” of the tool 100 (e.g., based on a temperature signature), and the control logic 118 may be configured to prevent actuation of the actuator 122 in response to a determination that it is likely that a human being is within the line of fire of the tool 100. Such a safety system may be advantageous over existing safety devices. For example, as discussed above, conventional nail guns may include a mechanical sensor on the nose piece that only requires that the nose piece be depressed before the nail gun will fire, but this doesn't prevent the nail gun from being pressed against a human being and actuated.

In some embodiments, the tool 100 may be configured to detect and store an identifier of the user currently or previously using the tool 100. In some embodiments, the sensors 108 may include an RF detector that may read RFID information stored in an employee's badge and require that information in the memory 116. In some embodiments, the sensors 108 may include a fingerprint detector to read fingerprint information from a user's hand. The monitoring logic 114 may be configured to cross-reference that fingerprint information with stored fingerprint/identity information in the memory 116, identify the current user by matching the current fingerprint information with stored fingerprint information, and store the identifier in the memory 116 (e.g., accompanied by a timestamp). This information may be maintained locally to the tool 100 and/or may be transmitted to the remote monitoring device 106 (e.g., via the communication interface 132). In some embodiments, the control logic 118 may be configured to only allow the tool 100 to operate when the tool 100 is being used by a particular user (e.g., a single user or a particular user out of an authorized group of users). Maintaining a record of who has been using the tool 100 may address a number of problems in various work environments. For example, it is not uncommon for workers in a construction setting to “borrow” each other's tools (e.g., because someone else's tool is nicer or functional). When this happens, the owner of the borrowed tool is both left without a tool, and must spend time tracking down the location of his or her tool. Thus, the “casual theft” of tools often results in a loss of productive time on the job, and can engender distrust among workers on a jobsite. To combat this, some workers lock up their tools when not in use, and this locking and unlocking also takes time away from the job at hand. Moreover, if a tool is damaged, there may be controversy over who was using it when the damage occurred. Monitoring who is using a particular tool (and in some embodiments, controlling operation of the device based on the user) may mitigate or solve these “borrowed tool” issues.

In some embodiments, the tool 100 may be configured to detect whether the tool 100 has been dropped or set down in a proper manner. As discussed above, the tool 100 may detect drops via an accelerometer and suitably configured monitoring logic 114, and may store criteria to distinguish between drops and proper placement. The dropping of tools may be a major maintenance issue in some settings, and thus the detection of drops may be a particularly important feature in some embodiments.

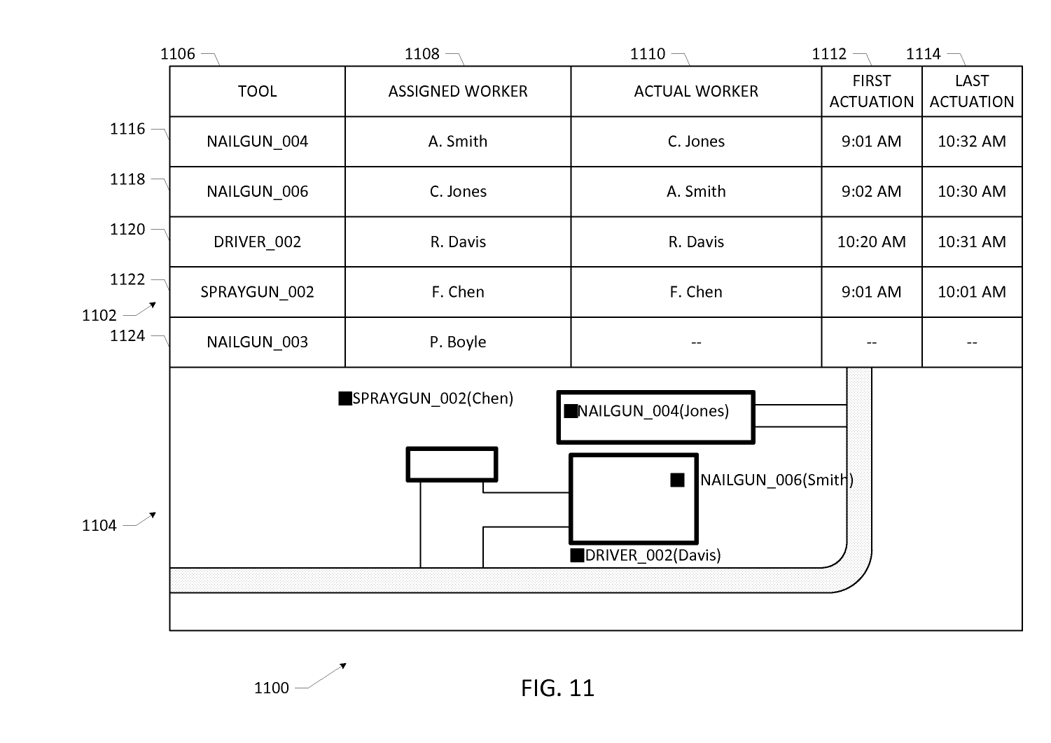

FIG. 11 depicts an illustrative graphical user interface (GUI) 1100 that may be displayed on the remote monitoring device 106 based on data provided by a number of tools configured as described above for various embodiments of the tool 100. The GUI 1100 includes a tabular portion 1102 and a map portion 1104. The tabular portion 1102 includes a tool field 1106, an assigned worker field 1108, an actual worker field 1110, a first actuation field 1112, a last actuation field 1114, and a number of entries 1116-1124. The tool field 1106 identifies a tool associated with an entry, the assigned worker field 1108 identifies the worker assigned to use the tool associated with the entry, the actual worker field 1110 identifies the worker currently or recently using the tool associated with the entry, the first actuation field 1112 indicates the time at which the tool associated with the entry was first actuated in the current day, and the last actuation field 1114 indicates the most recent time at which the tool associated with the entry was actuated.

The entries 1116-1124 illustrated in FIG. 11 are associated with five different tools, as shown. The entry 1116 indicates that the worker assigned to the tool NAILGUN_004 is not the same as the worker actually using the tool NAILGUN_004, which may be an issue (as discussed above). Inspection of the entry 1118 indicates that it appears that the workers assigned to the tools NAILGUN_004 and NAILGUN_006 have switched tools. The entry 1120 indicates that the worker assigned to the tool DRIVER_002 is the same as the worker actually using the tool DRIVER_002, but that the first actuation of the tool DRIVER_002 did not occur until 10:20 AM. If the start of the workday was 9 AM, this late start may be an issue (as discussed above). The entry 1122 indicates that the worker assigned to the tool SPRAYGUN_002 may have started the workday on time, but the last time of actuation was 10:01 AM. If the current time is much later than 10:01 AM, the worker assigned to the tool SPRAYGUN_002 may be on an unauthorized break. The entry 1124 indicates that no worker is currently or was recently using the tool NAILGUN_003, and thus the worker assigned to this tool may not have shown up for work at all.

The map portion 1104 may use location information about the various tools to detect the location of the various tools on a map of the jobsite. The identifiers of the tools may be accompanied by the worker currently or recently using the tool. In some embodiments, detailed information about the tools and workers may be accessed by selecting a tool identifier for a worker name in the tabular portion 1102 or the map portion 1104.

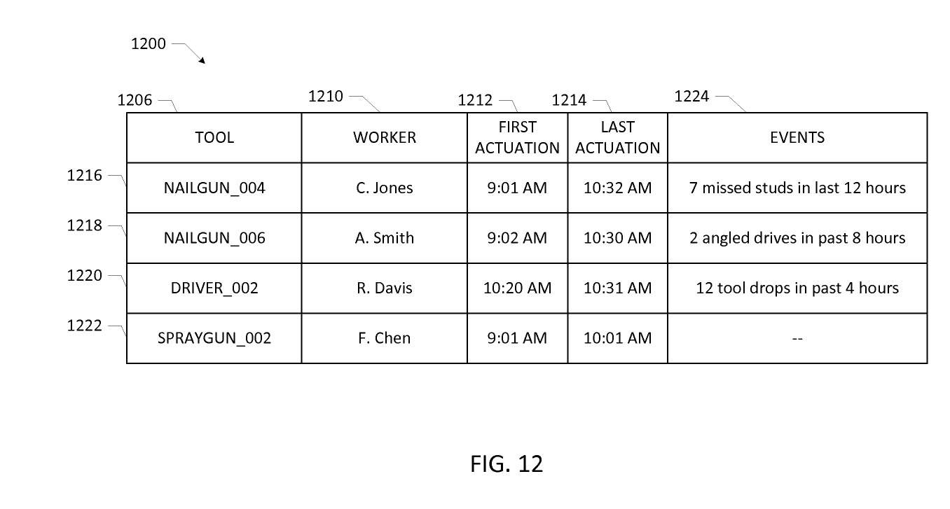

FIG. 12 depicts a second illustrative GUI 1200 that may be displayed on the remote monitoring device 106 based on data provided by a number of tools configured as described above for various embodiments of the tool 100. The GUI 1200 has a tabular form, and includes a tool field 1206, a worker field 1210 (which may be an assigned worker or an actual worker, as discussed above with reference to the fields 1108 and 1110 of the GUI 1100), a first actuation field 1212, a last actuation field 1214, an events field 1224, and a number of entries 1216-1222. The tool field 1206, the first actuation field 1212, and the last actuation field 1214 may take any of the forms discussed above for their counterparts in the GUI 1100 of FIG. 11. The events field 1224 may identify any events (e.g., occasions on which the tool 100 has satisfied a set of predetermined event conditions, as discussed herein) associated with the corresponding tool.

The entries 1216-1222 illustrated in FIG. 12 are associated with four different tools, as shown. The entry 1216 indicates that the monitoring logic 114 of the tool NAILGUN_004 has detected 7 missed studs in the last 12 hours (e.g., based on nail resistance, as discussed above). The entry 1218 indicates that the monitoring logic 114 of the tool NAILGUN_006 has detected 2 angled drives in the past 8 hours (e.g., based on nail angle, as discussed above). The entry 1220 indicates that the monitoring logic 114 of the tool DRIVER_002 has experienced 12 tool drops in the past 4 hours (e.g., based on accelerometer data, as discussed above). The entry 1222 indicates that the monitoring logic 114 of the tool SPRAYGUN_002 has not detected any predetermined event conditions within the monitoring period used.

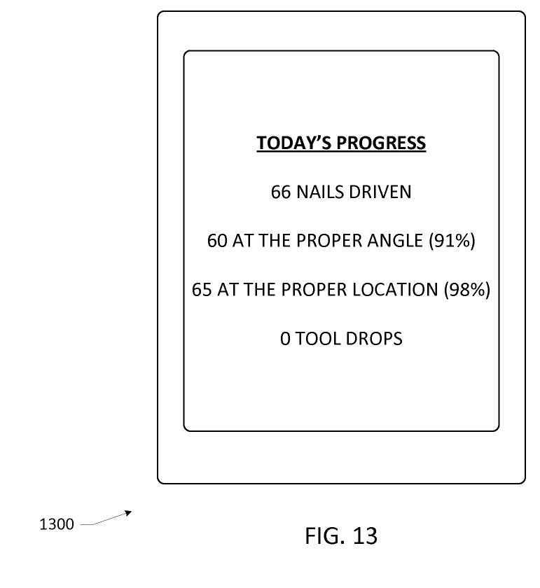

FIG. 13 depicts a third illustrative GUI 1300 that may be displayed on the remote monitoring device 106 based on data provided by a tool 100. The GUI 1300 may be particularly suitable for applications in which the remote monitoring device 106 is a personal computing device associated with the user of the tool 100 (e.g., a smartphone or tablet owned by the owner of the tool 100). Communication between the tool 100 and the remote monitoring device 106 in such applications may enable a user to self-monitor his or her performance, and share his or her performance data with friends or colleagues, as desired. In the GUI 1300, a summary of the daily use of the tool 100 is provided. This summary may include the number of nails driven, the number and percentage of nails driven at a proper angle (e.g., as determined by nail angle, as discussed above), the number and percentage of nails driven at a proper location (e.g., through a stud, as determined by nail resistance, as discussed above), and the number of tool drops. These statistics may represent the frequency of predetermined event conditions as determined by the monitoring logic 114, and any desired number of type of predetermined event conditions may be included in the GUI 1300 (over any desired period of time).

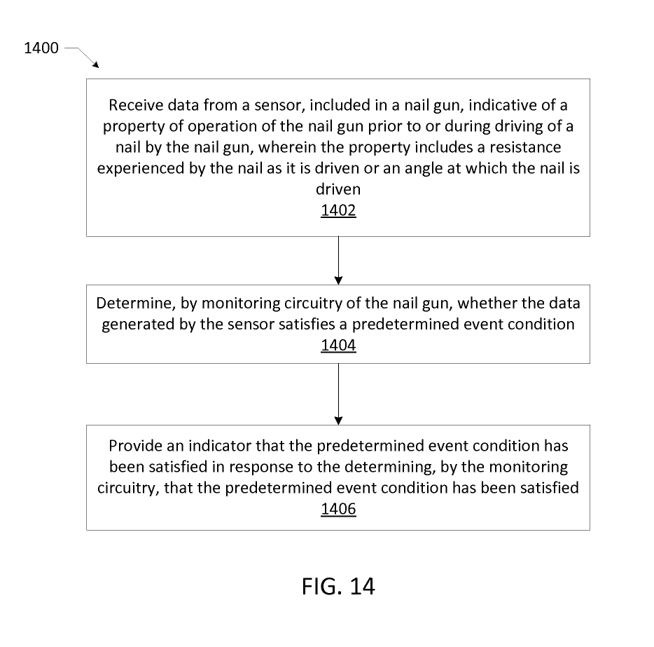

FIG. 14 is a flow diagram of a method 1400 for operating a tool, in accordance with various embodiments. Although operations of the method 1400 may be discussed with reference to the tool 100 and components thereof, this is simply for illustrative purposes and the method 1400 may be utilized with any suitable tool.

At 1402, data may be received from a sensor (e.g., the sensor 108), included in a nail gun (e.g., the nail gun 100), indicative of a property of operation of the nail gun prior to or during driving of a nail by the nail gun. The property may include a resistance experienced by the nail as it is driven or an angle at which the nail is driven.

In some embodiments, the property of 1402 may include a resistance experienced by the nail as it is driven. In some such embodiments, the nail gun may include a piston to drive the nail and the sensor may include an accelerometer arranged to generate data indicative of the acceleration of the piston. In some such embodiments, the predetermined event condition may include a resistance that falls below a predetermined threshold.

In some embodiments, the property of 1402 may include the angle at which the nail is driven. In some such embodiments, the sensor may include an optical sensor (e.g., a plurality of emitter-detector pairs located at a tool application interface of the nail gun). In some such embodiments, the sensor may include a magnetic sensor (e.g., first and second magnets, and is configured to generate an output signal based at least in part on a spacing between the first and second magnets). For example, the magnetic sensor may include a plurality of pairs of magnets proximate to a tool application interface of the nail gun, each pair of magnets including a first magnet spaced apart from a second magnet, wherein the first magnets of the plurality of pairs of magnets are adjustably positioned with reference to the second magnets of the plurality of pairs of magnets in response to adjustment of the orientation of the nail gun when the tool application interface is in contact with a workpiece. In some embodiments in which the property of 1402 includes the angle at which the nail is driven, the sensor may include an accelerometer. In some such embodiments, the method 1400 may further include receiving an indication from a user of the nail gun that a subsequent positioning of the nail gun is for calibration of the sensor or the monitoring circuitry. In some such embodiments, the predetermined event condition may include an angle that falls outside a range around a predetermined reference angle.

At 1404, monitoring circuitry (e.g., the monitoring logic 114) of the nail gun may determine whether the data generated by the sensor satisfies a predetermined event condition.

At 1406, an indicator may be provided that the predetermined event condition has been satisfied in response to the determining, by the monitoring circuitry, that the predetermined event condition has been satisfied. In some embodiments, providing the indicator that the predetermined event condition has been satisfied at 1406 may include providing an audible indicator. In some embodiments, providing an indicator that the predetermined event condition has been satisfied at 1406 may include illuminating a light on the nail gun. In some embodiments, providing an indicator that the predetermined event condition has been satisfied at 1406 may include vibrating the nail gun. In some embodiments, providing an indicator that the predetermined event condition has been satisfied at 1406 may include wirelessly transmitting data representative of the indicator to a remote monitoring device, wherein the remote monitoring device is to display at least some of the data representative of the indicator. In some embodiments, the data representative of the indicator may include an identifier of a user of the nail gun.

Additional operations may be included in various embodiments of the method 1400. For example, in some embodiments, the method 1400 may include receiving an indication from a user of the nail gun that a subsequent driving of a nail is for calibration of the sensor or the monitoring circuitry. In some embodiments, the method 1400 may include storing the predetermined event condition.

In some embodiments, collecting data on tool operation and maintenance across many tools configured similarly to the tool 100 may allow a company to establish a proper maintenance schedule, maintain tools individually as the need arises, and determine when is appropriate to hire in-house personnel to handle the most commonly arising problems (versus sending out tools for repair and maintenance, which can be costly in terms of time lost).

It has been observed that the population of workers in various industries, such as skilled manufacturing and construction labor, is getting older without a younger generation to take its place. For such industries to succeed, they may be wise to implement techniques for quickly bringing new, unskilled workers up to speed on proper tool usage. As discussed in detail herein, various embodiments of the tool 100 disclosed herein provide feedback to users and their managers to encourage proper tool use, and thus may be particularly useful in the training and monitoring of new employees.

Several examples of the distribution of operations between the components of the tool monitoring/control system 150 are discussed herein, but any other combination of more or fewer components and distribution of the operations may be used. Communication within the tool monitoring/control system 150 may be enabled by wired communication pathways and/or wireless communication pathways, over direct couplings, and/or over personal, local, and/or wide area networks. Each of the components of the tool monitoring/control system 150 may include suitable hardware for supporting the communication pathways, such as network interface cards, modems, Wi-Fi devices, Bluetooth devices, routers, switches, and so forth. Each of the components included in the tool monitoring/control system 150 may include one or more processing devices and one or more storage devices. The processing devices may include one or more processing cores, Application Specific Integrated Circuits (ASICs), electronic circuits, processors (shared, dedicated, or group), combinational logic circuits, and/or other suitable components that may be configured to process electronic data. The storage device(s) may include any suitable memory or mass storage devices (such as solid-state drive, diskette, hard drive, compact disc read only memory (CD-ROM), and so forth). The processing device(s) and storage device(s) may be configured to implement any of the logic disclosed herein, as appropriate. Each of the components included in the tool monitoring/control system 150 may include one or more buses (and bus bridges, if suitable) to communicatively couple the processing device, the storage device, and any other devices included in the respective components. The storage device may include a set of computational logic, which may include one or more copies of computer readable media (e.g., non-transitory computer readable media) having instructions stored therein which, when executed by the processing device of the computing device, may cause the component to implement any of the techniques and methods disclosed herein, or any portion thereof.

The following paragraphs describe examples of various ones of the embodiments disclosed herein.

Example 1 is a nail gun, including: a trigger; an actuator, coupled to the trigger, to drive a nail in response to a pull of the trigger; a sensor to generate data indicative of a property of operation of the nail gun prior to or during driving of a nail, wherein the property includes a resistance experienced by the nail as it is driven or an angle at which the nail is driven; monitoring circuitry, coupled with the sensor, to determine whether the data generated by the sensor satisfies a predetermined event condition; and an output interface, coupled with the monitoring circuitry, to provide an indicator that the predetermined event condition has been satisfied in response to a determination by the monitoring circuitry that the predetermined event condition has been satisfied.

Example 2 may include the subject matter of Example 1, and may further include an input device to receive an indication from a user of the nail gun that a subsequent driving of a nail is for calibration of the sensor or the monitoring circuitry.

Example 3 may include the subject matter of any of Examples 1-2, and may further specify that the property includes the resistance experienced by the nail as it is driven.

Example 4 may include the subject matter of Example 3, and may further specify that the actuator includes a piston and the sensor includes an accelerometer arranged to generate data indicative of an acceleration of the piston.

Example 5 may include the subject matter of any of Examples 3-4, and may further specify that the predetermined event condition includes a resistance that falls below a predetermined threshold.

Example 6 may include the subject matter of any of Examples 1-5, and may further specify that the property includes the angle at which the nail is driven.

Example 7 may include the subject matter of Example 6, and may further specify that the sensor includes an optical sensor.

Example 8 may include the subject matter of Example 7, and may further specify that the sensor includes an emitter-detector pair.

Example 9 may include the subject matter of Example 8, and may further specify that the sensor includes a plurality of emitter-detector pairs located at a tool application interface of the nail gun.

Example 10 may include the subject matter of any of Examples 6-9, and may further specify that the sensor includes a magnetic sensor.

Example 11 may include the subject matter of Example 10, and may further specify that the magnetic sensor includes first and second magnets and is configured to generate an output signal based at least in part on a spacing between the first and second magnets.

Example 12 may include the subject matter of any of Examples 6-11 and may further specify that the sensor includes an accelerometer.

Example 13 may include the subject matter of any of Examples 6-12, and may further include an input device to receive an indication from a user of the nail gun that a subsequent positioning of the nail gun is for calibration of the sensor or the monitoring circuitry.

Example 14 may include the subject matter of any of Examples 6-13, and may further specify that the predetermined event condition includes an angle that falls outside a range around a predetermined reference angle.

Example 15 may include the subject matter of any of Examples 1-14, and may further specify that the monitoring circuitry includes a memory to store the predetermined event condition.

Example 16 may include the subject matter of any of Examples 1-15, and may further specify that the output interface includes an audio interface, and the indicator includes an audible indicator.

Example 17 may include the subject matter of any of Examples 1-16, and may further specify that the output interface includes a visual interface, and the indicator includes a light.

Example 18 may include the subject matter of any of Examples 1-17, and may further specify that the output interface includes a tactile interface, and the indicator includes a vibration of the nail gun.

Example 19 may include the subject matter of any of Examples 1-18, and may further specify that the output interface includes a communication interface, the communication interface is to wirelessly transmit data representative of the indicator to a remote monitoring device, and the remote monitoring device is to display at least some of the data representative of the indicator.

Example 20 may include the subject matter of Example 19, and may further specify that the data representative of the indicator includes an identifier of a user of the nail gun.

Example 21 may include the subject matter of Example 20, and may further specify that the magnetic sensor includes a plurality of pairs of magnets proximate to a tool application interface of the nail gun, each pair of magnets including a first magnet spaced apart from a second magnet, wherein the first magnets of the plurality of pairs of magnets are adjustably positioned with reference to the second magnets of the plurality of pairs of magnets in response to adjustment of an orientation of the nail gun when the tool application interface is in contact with a workpiece.

Example 22 is one or more computer readable media having instructions thereon that, in response to execution by one or more processing devices of a remote monitoring device, cause the remote monitoring device to communicate with the nail gun of any of Examples 1-21 and to display at least some of the data representative of the indicator.

Example 23 is a remote monitoring device including circuitry to receive, from the nail gun of any of Examples 1-21, the indicator that the predetermined event condition has been satisfied in response to a determination by the monitoring circuitry that the predetermined event condition has been satisfied, and to display at least some of the data representative of the indicator.

Example 24 is a method for operating a nail gun, including: receiving data from a sensor, included in the nail gun, indicative of a property of operation of the nail gun prior to or during driving of a nail by the nail gun, wherein the property includes a resistance experienced by the nail as it is driven or an angle at which the nail is driven; determining, by monitoring circuitry of the nail gun, whether the data generated by the sensor satisfies a predetermined event condition; and providing an indicator that the predetermined event condition has been satisfied in response to the determining that the predetermined event condition has been satisfied.

Example 25 may include the subject matter of Example 24, and may further include receiving an indication from a user of the nail gun that a subsequent driving of a nail is for calibration of the sensor or the monitoring circuitry.

Example 26 may include the subject matter of any of Examples 24-25, and may further specify that the property includes the resistance experienced by the nail as it is driven.

Example 27 may include the subject matter of Example 26, and may further specify that the nail gun includes a piston to drive the nail and the sensor includes an accelerometer arranged to generate data indicative of an acceleration of the piston.

Example 28 may include the subject matter of any of Examples 26-27, and may further specify that the predetermined event condition includes a resistance that falls below a predetermined threshold.

Example 29 may include the subject matter of any of Examples 24-28, and may further specify that the property includes the angle at which the nail is driven.

Example 30 may include the subject matter of Example 29, and may further specify that the sensor includes an optical sensor.

Example 31 may include the subject matter of Example 30, and may further specify that the sensor includes an emitter-detector pair.

Example 32 may include the subject matter of Example 31, and may further specify that the sensor includes a plurality of emitter-detector pairs located at a tool application interface of the nail gun.

Example 33 may include the subject matter of any of Examples 29-32, and may further specify that the sensor includes a magnetic sensor.

Example 34 may include the subject matter of Example 33, and may further specify that the magnetic sensor includes first and second magnets and is configured to generate an output signal based at least in part on a spacing between the first and second magnets.

Example 35 may include the subject matter of any of Examples 29-34 and may further specify that the sensor includes an accelerometer.

Example 36 may include the subject matter of any of Examples 29-35, and may further include receiving an indication from a user of the nail gun that a subsequent positioning of the nail gun is for calibration of the sensor or the monitoring circuitry.

Example 37 may include the subject matter of any of Examples 29-36, and may further specify that the predetermined event condition includes an angle that falls outside a range around a predetermined reference angle.

Example 38 may include the subject matter of any of Examples 24-37, and may further include storing the predetermined event condition.

Example 39 may include the subject matter of any of Examples 24-38, and may further specify that providing an indicator that the predetermined event condition has been satisfied includes providing an audible indicator.

Example 40 may include the subject matter of any of Examples 24-39, and may further specify that providing an indicator that the predetermined event condition has been satisfied includes illuminating a light on the nail gun.

Example 41 may include the subject matter of any of Examples 24-40, and may further specify that providing an indicator that the predetermined event condition has been satisfied includes vibrating the nail gun.

Example 42 may include the subject matter of any of Examples 24-41, and may further specify that providing an indicator that the predetermined event condition has been satisfied includes wirelessly transmitting data representative of the indicator to a remote monitoring device, wherein the remote monitoring device is to display at least some of the data representative of the indicator.

Example 43 may include the subject matter of Example 42, and may further specify that the data representative of the indicator includes an identifier of a user of the nail gun.

Example 44 may include the subject matter of Example 43, and may further specify that the magnetic sensor includes a plurality of pairs of magnets proximate to a tool application interface of the nail gun, each pair of magnets including a first magnet spaced apart from a second magnet, wherein the first magnets of the plurality of pairs of magnets are adjustably positioned with reference to the second magnets of the plurality of pairs of magnets in response to adjustment of an orientation of the nail gun when the tool application interface is in contact with a workpiece.

Example 45 is an apparatus including means for performing the method of any of Examples 24-44.

Example 46 is one or more computer readable media having instructions thereon that, when executed by one or more processing devices of a computing device, cause the computing device to perform the method of any of Examples 24-44.

What is claimed is:

1. A nail gun, comprising:
a trigger;
an actuator, coupled to the trigger, to drive a nail in response to a pull of the trigger;
a sensor to generate data indicative of a property of operation of the nail gun prior to or during driving of a nail, wherein the property includes a resistance experienced by the nail as it is driven or an angle at which the nail is driven;
monitoring circuitry, coupled with the sensor, to determine whether the data generated by the sensor satisfies a predetermined event condition; and
an output interface, coupled with the monitoring circuitry, to provide an indicator that the predetermined event condition has been satisfied in response to a determination by the monitoring circuitry that the predetermined event condition has been satisfied.

2. The nail gun of claim 1, further comprising an input device to receive an indication from a user of the nail gun that a subsequent driving of a nail is for calibration of the sensor or the monitoring circuitry.

3. The nail gun of claim 1, wherein the property includes the resistance experienced by the nail as it is driven.

4. The nail gun of claim 3, wherein the actuator comprises a piston and the sensor comprises an accelerometer arranged to generate data indicative of an acceleration of the piston.

5. The nail gun of claim 3, wherein the predetermined event condition comprises a resistance that falls below a predetermined threshold.

6. The nail gun of claim 1, wherein the property includes the angle at which the nail is driven.

7. The nail gun of claim 6, wherein the sensor comprises an optical sensor.

8. The nail gun of claim 7, wherein the sensor comprises an emitter-detector pair.

9. The nail gun of claim 8, wherein the sensor comprises a plurality of emitter-detector pairs located at a tool application interface of the nail gun.

10. The nail gun of claim 6, wherein the sensor comprises a magnetic sensor.

11. The nail gun of claim 10, wherein the magnetic sensor comprises first and second magnets and is configured to generate an output signal based at least in part on a spacing between the first and second magnets.

12. The nail gun of claim 6, wherein the sensor comprises an accelerometer.

13. The nail gun of claim 6, further comprising an input device to receive an indication from a user of the nail gun that a subsequent positioning of the nail gun is for calibration of the sensor or the monitoring circuitry.

14. The nail gun of claim 6, wherein the predetermined event condition comprises an angle that falls outside a range around a predetermined reference angle.

15. The nail gun of claim 1, wherein the monitoring circuitry comprises a memory to store the predetermined event condition.

16. The nail gun of claim 1, wherein the output interface comprises an audio interface, and the indicator comprises an audible indicator.

17. The nail gun of claim 1, wherein the output interface comprises a visual interface, and the indicator comprises a light.

18. The nail gun of claim 1, wherein the output interface comprises a tactile interface, and the indicator comprises a vibration of the nail gun.

19. The nail gun of claim 1, wherein the output interface comprises a communication interface, the communication interface is to wirelessly transmit data representative of the indicator to a remote monitoring device, and the remote monitoring device is to display at least some of the data representative of the indicator.

20. The nail gun of claim 19, wherein the data representative of the indicator comprises an identifier of a user of the nail gun.
